(19) United States
(12) Patent Application Publication
(10) Pub. No.: US 2026/0303387 A1
(43) Pub. Date: Oct. 1, 2026

(54) SWITCH PORT CONFIGURATION BASED ON SILENT HOST TYPE

(71) Applicant: HEWLETT PACKARD ENTERPRISE DEVELOPMENT LP, Spring, TX (US)

(72) Inventors: Balaji Sankaran, Bangalore (IN); Venkatavaradhan Devarajan, Bangalore (IN); Abhay Bhaskar, Bangalore (IN)

(21) Appl. No.: 19/225,359

(22) Filed: Jun. 2, 2025

(30) Foreign Application Priority Data
Mar. 28, 2025 (IN) 202541030000

(51) Int. Cl. H04L 12/12; H04L 45/00; H04L 45/02

(52) U.S. Cl. CPC H04L 12/12; H04L 45/02; H04L 45/66

(57) ABSTRACT

A network switch includes a port to connect an electronic device. The network switch can detect that the electronic device is a silent host, and the network switch can classify the electronic device as a selected silent host type from different silent host types, the classifying based on identifying an interaction, from among different types of interactions, between the network switch and the electronic device. The different types of interactions indicate respective silent host types of the different silent host types. The network switch can set a configuration associated with the port based on the selected silent host type produced by the classifying.

### BACKGROUND

A network can include network switches to which electronic devices can connect. A network switch includes multiple ports. A data packet sent by an electronic device can be received at a first port of the network switch, and the network switch can forward the data packet through a second port of the network switch to propagate the data packet along a network path to a destination device.

### BRIEF DESCRIPTION OF THE DRAWINGS

Some implementations of the present disclosure are described with respect to the following figures.

FIG. 1 is a block diagram of an arrangement including a switch, silent hosts connected to ports of the switch, and an authentication server, according to some examples.

FIG. 2 is a flow diagram of a process performed by the switch, according to some examples.

FIG. 3 is a block diagram of a switch according to some examples.

FIG. 4 is a block diagram of a storage medium storing machine-readable instructions according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Different types of electronic devices can connect to ports of network switches. In some examples, a network switch can include colorless ports, which are ports of the network switch that initially share a common port configuration ("initial port configuration"). A colorless port can connect to any of various different types of electronic devices. When an electronic device connects to a colorless port of a network switch, the electronic device can perform an authentication process with an authentication server. Based on the type of electronic device connected to the colorless port, the authentication server can specify a port configuration for the colorless port, where the specified port configuration can differ from the initial port configuration.

In some cases, an electronic device that connects to a colorless port of a network switch may be a silent host. A silent host refers to an electronic device that either (1) does not transmit any information when the electronic device connects to the switch port (i.e., the electronic device does not announce itself), or (2) goes silent after an authentication process between the electronic device and the authentication server through the network switch. A silent host that never announces itself can be referred to as an "ultra-silent host." An ultra-silent host connected to a switch port may not be authenticated and onboarded by the network switch, which means that the ultra-silent host is not reachable through the network switch. A silent host that goes silent after an authentication process is referred to as a "shy silent host." An issue associated with a shy silent host is that information for the shy silent host may be removed as a result of the shy silent host going silent after the authentication process. After the information for the shy silent host is removed, the shy silent host is not reachable through the network switch.

In accordance with some implementations of the present disclosure, a network switch can detect that an electronic device connected to a port (e.g., a colorless port or any other type of port) of the network switch is a silent host, and the network switch can classify the electronic device as being of a specific silent host type from multiple different silent host types. The classifying is based on identifying an interaction, from among different types of interactions, between the network switch and the electronic device. The different types of interactions indicate respective different silent host types. The network switch can set a port configuration associated with the port based on the specific silent host type produced by the classifying.

In some examples, the different types of interactions include (1) a first type of interaction in which inactivity of the electronic device causes a connection of the port to go down due to the electronic device transitioning to a sleep mode, (2) a second first type of interaction in which inactivity of the electronic device causes the host information of the electronic device to age out, (3) a third type of interaction in which the electronic device does not announce itself but responds to a broadcast packet targeting a broadcast address, and (4) a fourth type of interaction in which the electronic device does not announce itself but responds to a directed broadcast packet targeting a subnet. In such examples, interaction type (1) indicates a hibernating shy silent host, interaction type (2) indicates a non-hibernating shy silent host, interaction types (3) and (4) indicate different types of ultra-silent hosts.

A "network switch" (or more simply a "switch") can refer to any type of network device in a network that forwards a data packet received from a source device to propagate along a network path towards a destination device. The switch may include a layer 2 switch, a layer 3 router, or any other type of network device that forwards data packets.

A port configuration of a port of a switch can include any or some combination of the following: an identifier of a virtual network, such as a virtual local area network (VLAN), defined on the port; a policy associated with the port for enforcing actions with respect to data packets received at or to be transmitted through the port, or another property associated with the port.

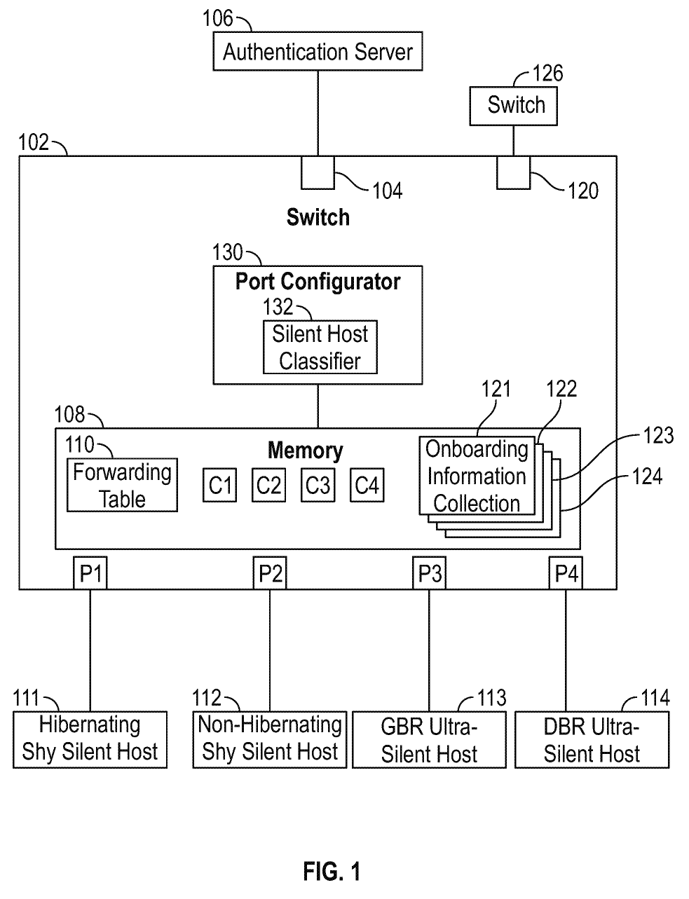

FIG. 1 is a block diagram of an example arrangement that includes a switch 102 that can connect to various electronic devices to allow the electronic devices to communicate over a network with other endpoint devices. The switch 102 has various ports, including ports P1, P2, P3, and P4 connected to respective electronic devices.

The switch 102 also includes a port 104 connected to an authentication server 106 that authenticates electronic devices using authentication processes. An example of the authentication server 106 is a Remote Authentication Dial-In User Service (RADIUS) server, which operates according to the RADIUS protocol that provides centralized authentication, authorization, and accounting (AAA) management for client devices that connect and use a network resource or service. In other examples, the authentication server 106 can operate according to another protocol, such as the Lightweight Directory Access Protocol (LDAP) (an open-source authentication protocol), the Terminal Access Controller Access-Control System (TACACS) protocol, TACACS Plus (TACACS+) protocol, or another authentication protocol.

The switch 102 additionally includes a port 120 connected to another switch 126. The switch 126 can be connected to endpoint devices or other switches. Data packets can be propagated to the switch 126 for forwarding to the endpoint devices or to other endpoint devices coupled to other switches. Generally, one or more switches can be connected in a network path between a first device and a second device. Although a specific quantity of ports are shown in FIG. 1, in other examples, the switch 102 can include a different quantity of ports.

In the example of FIG. 1, the electronic devices connected to ports P1, P2, P3, and P4 are different types of silent hosts. Other ports of the switch 102 may be connected to non-silent hosts. The electronic device connected to port P1 is a hibernating shy silent host 111. The electronic device connected to port P2 is a non-hibernating shy silent host 112. The electronic device connected to port P3 is a general-broadcast-responsive (GBR) ultra-silent host 113. The electronic device connected to port P4 is a directed-broadcast-responsive (DBR) ultra-silent host 114. Note that an ultra-silent host (either a GBR ultra-silent host or a DBR ultra-silent host) can also be classified as hibernating or non-hibernating.

A shy silent host refers to an electronic device that goes silent after an authentication process between the electronic device and the authentication server 106 through the switch 102. In other words, the shy silent host, after the authentication process, does not initiate communications with other endpoint devices. Examples of shy silent hosts include any or some combination of the following: a network printer that is accessible over a network, a security controller that receives user information (e.g., biometric information, information of a badge, etc.) for authorizing users, and so forth.

In some examples, a shy silent host supports a discovery mechanism by which the shy silent host announces itself in a discovery process. The discovery process may be according to the Dynamic Host Configuration Protocol (DHCP), which is a network management protocol for assigning Internet Protocol (IP) addresses and other parameters to electronic devices connected to the network. After the discovery process, the shy silent host is onboarded at the switch 102, where the onboarding includes performing an authentication process between the shy silent host and the authentication server 106 to authenticate the shy silent host. Once the electronic device is onboarded at the switch 102, onboarding information can be created for the electronic device. For example, as part of onboarding the hibernating shy silent host 111, the switch 102 can create an onboarding information collection 121 for the hibernating shy silent host 111. Similarly, as part of onboarding the non-hibernating shy silent host 112, the switch 102 can create an onboarding information collection 122 for the non-hibernating shy silent host 112.

An onboarding information collection for an electronic device can include any or some combination of the following attributes: a client policy for the electronic device (where the client policy can be based on the role of the electronic device, with examples roles including an "employee" role, a "guest" role, a "technician" role, etc.); session attributes such as session time (indicating an amount of time that a session of the electronic device is active), a reauthentication time (a time interval after which the electronic device should be reauthenticated), or a maximum transmission unit (MTU) parameter that governs the maximum packet size of data packets that can be communicated with the electronic device; and other attributes. The onboarding information collections 121 and 122 can be stored in a memory 108 of the switch 102.

The memory 108 can also store a forwarding table 110, which is used by the switch 102 to forward data packets received from electronic devices to network paths through other ports of the switch 102. In some examples, the forwarding table 110 includes a Media Access Control (MAC) address table that maps MAC addresses of electronic devices to respective ports of the switch 102. For example, an entry for a particular electronic device connected to a given port of the switch 102 maps the MAC address of the particular electronic device to the given port. When an electronic device is onboarded, an entry for the electronic device is added to the forwarding table 110. In response to receiving a data packet sent by a source device and containing a destination MAC address of the particular electronic device, the switch 102 can retrieve the entry of the forwarding table 110 for the particular electronic device, and determine based on the entry the given port that the data packet should be sent through.

Similarly, another entry can be added to the forwarding table 110 for the non-hibernating shy silent host 112. Onboarding information collections 123 and 124 can also be created in the memory 108 for the ultra-silent hosts 113 and 114, respectively, in response to onboarding the ultra-silent hosts 113 and 114. Also, entries for the ultra-silent hosts 113 and 114 can be added to the forwarding table 110.

Collectively, an onboarding information collection and an entry in the forwarding table 110 for electronic device Y (which can be any of silent hosts 111 to 114 or other types of electronic devices) is referred to as "host information" for electronic device Y. The host information maintained by the switch 102 for electronic device Y allows communications from and to electronic device Y through the switch 102. If the host information for electronic device Y is not present in the switch 102, then communications with electronic device Y would not be possible.

An issue associated with a shy silent host (either the hibernating shy silent host 111 or the non-hibernating shy silent host 112) is that the host information for the shy silent host may be removed by the switch 102 as a result of the shy silent host going silent after the authentication process. The host information removed may include the onboarding information collection (121 or 122) for the shy silent host, and an entry of the forwarding table 110 for the shy silent host.

The hibernating shy silent host 111 can go into a sleep mode, which is a lower power mode in which activity of the hibernating shy silent host 111 stops. When the hibernating shy silent host 111 enters the sleep mode, the switch 102 can make a determination that port P1 is no longer connected to an electronic device, and the switch 102 can terminate the connection between port P1 and the hibernating shy silent host 111. The terminated connection can be a layer 1 (physical layer) connection. As a result of the connection being terminated, the host information for the hibernating shy silent host 111 is removed from the switch 102.

If the hibernating shy silent host 111 is to transition from the sleep mode to an active mode at a later time, the hibernating shy silent host 111 will not initiate another authentication procedure since the hibernating shy silent host 111 has already been assigned an IP address in a prior DHCP process. As a result, the hibernating shy silent host 111 transitioning from the sleep mode to the active mode would not be onboarded again. This means that the host information removed due to the hibernating shy silent host 111 entering sleep mode will not be recovered at the switch 102, so that communications with the hibernating shy silent host 111 would no longer be possible.

The non-hibernating shy silent host 112 does not enter sleep mode. However, even though the non-hibernating shy silent host 112 does not enter sleep mode, it nevertheless does not send traffic after authentication with the authentication server 106. The switch 102 can have an age-out feature enabled for an electronic device. The age-out feature defines an inactivity time interval. If an electronic device (e.g., the non-hibernating shy silent host 112) has been inactive for longer than the inactivity time interval, the host information of the electronic device is aged out, i.e., removed from the switch 102.

An ultra-silent host does not transmit any information when the electronic device connects to the switch port (i.e., the electronic device does not announce itself). Unlike a shy silent host, the ultra-silent host does not perform a DHCP process and also does not perform an authentication process with the authentication server 106 when the ultra-silent host connects to a port of the switch 102. As a result, the ultra-silent host connected to the switch 102 may not be authenticated and onboarded by the switch 102, which means that communications with the ultra-silent host is not possible.

An ultra-silent host can be either a GBR ultra-silent host (e.g., 113 connected to port P3) or a DBR ultra-silent host (e.g., 114 connected to port P4). The GBR ultra-silent host 113 responds to a broadcast packet sent to a broadcast address. A broadcast packet targeted to the broadcast address is sent across all ports of the switch 102 for receipt by multiple electronic devices.

The DBR ultra-silent host 114 responds to directed broadcasts, which are broadcasts sent to a specific IP subnet (an IP subnet includes a range of IP addresses). A directed broadcast has an address representing the IP subnet, so that electronic devices connected to the IP subnet would receive the directed broadcast packet.

In accordance with some examples of the present disclosure, the switch 102 includes a port configurator 130 that can set respective port configurations C1, C2, C3, and C4 for respective ports P1, P2, P3, and P4. The port configuration set by the port configurator 130 for a respective port is based on the type of electronic device connected to the respective port. In some examples of the present disclosure, the port configurator 130 can set different port configurations for different silent host types.

The port configurator 130 includes a silent host classifier 132 to classify an electronic device connected to a port of the switch 102 as being one of various different types of silent hosts ("silent host types"). The classifying performed by the silent host classifier 132 is based on identifying a specific type of interaction between the switch 102 and the respective silent host. Different types of interactions between the switch 102 and respective different silent hosts indicate corresponding different silent host types.

The port configuration C1 set for port P1 is based on classifying the electronic device connected to port P1 as being the hibernating shy silent type. The port configuration C2 set for port P2 is based on classifying the electronic device connected to port P2 as being the non-hibernating shy silent type. The port configuration C3 set for port P3 is based on classifying the electronic device connected to port P3 as being the GBR ultra-silent type. The port configuration C4 set forth port P4 is based on classifying the electronic device connected to port P4 as being the DBR ultra-silent type.

The port configuration C1 set for port P1 that is connected to the hibernating shy silent host 111 includes configuration information indicating that host information of the electronic device (hibernating shy silent host 111) connected to port P1 is to be kept at the switch 102. For example, the configuration information can indicate that the host information of the hibernating shy silent host 111 is to be cached, such as in the memory 108. By caching the host information of the hibernating shy silent host 111, the host information of the hibernating shy silent host 111 can be recovered if the host information were removed for any reason, such as due to the connection between port P1 and the hibernating shy silent host 111 being terminated due to the hibernating shy silent host 111 transitioning to the sleep mode. After the hibernating shy silent host 111 transitions to the sleep mode and subsequently exits the sleep mode and returns to the active mode, the cached host information can be used by the switch 102 to repopulate the onboarding information collection 121 and the entry of the forwarding table 110 for the hibernating shy silent host 111.

In further examples, the configuration C1 can also enable a wake-on-network feature for port P1 to allow a transmission of a network packet through port P1 to awaken the hibernating shy silent host 111 from the sleep mode. An example of the wake-on-network feature is a wake-on-LAN feature that allows network packets sent over a LAN (or another type of network) to awaken a sleeping electronic device.

The port configuration C2 set for port P2 that is connected to the non-hibernating shy silent host 112 includes configuration information to disable an age-out feature to ensure that the host information for the non-hibernating shy silent host 112 is not aged out due to traffic inactivity of the non-hibernating shy silent host 112. If the age-out feature for port P2 is active, then the switch 102 would delete the host information for the non-hibernating shy silent host 112 in response to inactivity of port P2 that exceeds an inactivity time interval.

The port configuration C3 set for port P3 that is connected to the GBR ultra-silent host 113 can include configuration information indicating that a client broadcast probe service is activated for port P3 to allow transmission of a broadcast packet containing a broadcast address through port P3. Although the client broadcast probe service is activated for port P3, the client broadcast probe service can be disabled for some other ports of the switch 102 so that broadcast packets are not sent to these other ports.

The port configuration C4 set for port P4 that is connected to the DBR ultra-silent host 114 can include configuration information indicating that a client directed broadcast probe service is activated for port P4 to allow transmission of a directed broadcast packet containing an address of an IP subnet through port P4. Although the client directed broadcast probe service is activated for port P4, the client directed broadcast probe service can be disabled for some other ports of the switch 102 so that directed broadcast packets are not sent to these other ports.

An ultra-silent host can also be hibernating or non-hibernating. Accordingly, each of port configurations C3 and C4 can include (1) configuration information indicating that the host information of the respective ultra-silent host is to be cached if the respective ultra-silent host is a hibernating ultra-silent host, or (2) configuration information to disable an age-out feature to ensure that the host information for the non-hibernating ultra-silent host is not aged out due to traffic inactivity of the non-hibernating ultra-silent host.

### Switch Process

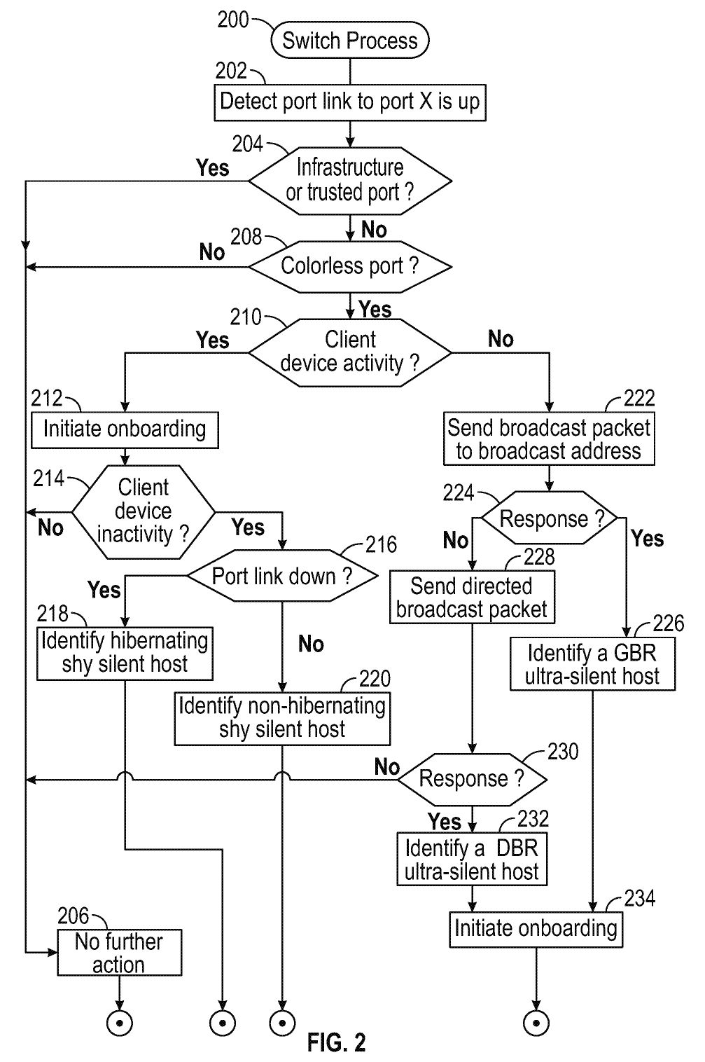

The following refers to both FIGS. 1 and 2. FIG. 2 is a flow diagram of a process 200 performed at the switch 102, in accordance with some examples of the present disclosure. The switch 102 detects (at 202) that a port link to port X is up. This means that port X, which was previously not connected, has been connected to an electronic device. Port X can be any of ports P1 to P4 or another port of the switch 102.

In response to detecting that the port link to port X is up, the switch 102 determines (at 204) whether port X is an infrastructure port or a trusted port. An infrastructure port of the switch 102 is a port to which an infrastructure device, such as a hub, an access point (AP), a switch, or any other type of infrastructure device, is connected. More generally, an infrastructure device is a device that supports data communications by other electronic devices, which are referred to as "client devices." An infrastructure port is not an access port. An access port is connected to a client device such as the silent hosts 111 to 114.

A trusted port is a port for which authentication is not enabled. Authentication is not enabled for a trusted port because the trusted port can inherently be trusted. An example of a trusted port is the port 104 connected to the authentication server 106.

If port X is an infrastructure port or a trusted port, then the switch 102 takes no further action (at 206) in the process 200. However, if port X is neither an infrastructure port nor a trusted port, the switch 102 determines (at 208) whether port X is a colorless port. If not, then the switch 102 takes no further (at 206) in the process 200. A colorless port is a port for which the type of client device connected is unknown. However, the switch 102 is provided with information identifying the type of client device connected to a non-colorless port.

If port X is a colorless port, the switch 102 proceeds to perform further actions relating to port X, which may potentially be connected to a silent host. The switch 102 determines (at 210) whether client device activity of the client device connected to port X is detected. If the client device is an ultra-silent host, then no activity is detected, and the switch 102 follows the "No" path from the decision block 210. However, if client device activity is detected, then the client device may be a shy silent host or a non-silent host. As a result, the switch 102 follows the "Yes" path from decision block 210.

If client device activity is detected, which can include messages exchanged as part of a DHCP process between the client device and a DHCP server, the switch 102 initiates (at 212) an onboarding procedure, which includes an authentication process. The authentication process that is initiated causes the client device connected to port X to perform an authentication process with the authentication server 106. Onboarding of the client device includes creating an onboarding information collection (e.g., any of 121 to 124) for the client device, and adding an entry to the forwarding table 110 for the client device.

The silent host classifier 132 of the switch 102 determines (at 214) whether client device inactivity is detected. Client device inactivity can be defined as inactivity of the client device for longer than a specified inactivity time duration, such as 5 minutes or another example duration.

If the client device connected to port X is not a silent host, then the client device would continue to communicate data, and thus, client device inactivity would not be detected. If client device inactivity is not detected, the switch 102 takes no further action (at 206) in the process 200.

If client device inactivity is detected, which indicates that the client device connected to port X is a silent host, the silent host classifier 132 determines (at 216) whether the port link to port X is down. The port link is terminated if the shy silent host is a hibernating shy silent host (e.g., 111 in FIG. 1). If the shy silent host is non-hibernating, then the port link to port X does not go down.

If the silent host classifier 132 determines (at 216) that the port link has gone down, then the silent host classifier 132 identifies (at 218) the client device connected to port X as a hibernating shy silent host (e.g., 111 in FIG. 1). However, if the port link to port X does not go down, then the silent host classifier 132 identifies (at 220) the client device connected to port to X as a non-hibernating shy silent host (e.g., 112 in FIG. 1).

Following the "No" path from decision block 210 (for an ultra-silent host), the switch 102 sends (222) a broadcast packet containing a broadcast address through port X. The switch 102 determines (at 224) whether a response to the broadcast packet is received. If a response to the broadcast packet is received, the silent host classifier 132 identifies (at 226) the client device connected to port X as a GBR ultra-silent host (e.g., 113 in FIG. 1).

On the other hand, if a response to the broadcast packet is not received after some expiration time duration, the switch 102 sends (at 228) a directed broadcast packet to an IP address representing an IP subnet. The switch 102 determines (at 230) whether a response to the directed broadcast packet is received. If not, no further action is taken (at 206), since the client device cannot be classified as an ultra-silent host.

If a response to the directed broadcast packet is received, the silent host classifier 132 identifies (at 232) the client device connected to port to X as a DBR ultra-silent host (e.g., 114 in FIG. 1).

From task 226 or 232, the switch 102 initiates (at 234) an onboarding procedure for the identified ultra-silent host, which includes performing an authentication process.

### VXLAN Deployment

In further examples, a network including the switches 102, 126 (as well as other switches) can include an "underlay and overlay network," in which frames of a layer 2 overlay network are carried in a layer 3 underlay network. The layer 3 underlay network can include an IP underlay network, and the layer 2 overlay network can include an Ethernet network. A protocol that supports communications through a layer 2 overlay network provided over a layer 3 underlay network is the Virtual Extensible Local Area Network (VXLAN) protocol. According to the VXLAN protocol, virtual tunnels referred to as VXLAN tunnels can be established between virtual tunnel endpoints (VTEPs) to communicate data. In the example of FIG. 1, the VTEPs can be included in the switches 102 and 126. A VXLAN tunnel encapsulates layer 2 frames of the layer 2 overlay network as payloads in layer 3 packets. The layer 3 packets are communicated through the layer 3 underlay network.

VTEPs in switches are part of the data plane of the network, where the data plane carries data packets between devices. A control plane of the network for exchanging control information between switches can operate according to the Ethernet Virtual Private Network (EVPN) technology.

A network that operates according to VXLAN and EVPN may be referred to as a "VXLAN network." Although reference is made to EVPN and VXLAN in some examples for establishing virtual tunnels between network devices, it is noted that in other examples, other types of virtual tunnel technologies may be employed, whether open source, standardized, or proprietary. Examples of other virtual tunnel technologies include the following: a Multiprotocol Label Switching (MPLS)-over-Generic Routing Encapsulation (GRE) technology, a Network Virtualization using GRE (NVGRE) technology, or any other technology for establishing virtual tunnels.

In a VXLAN network (or another network that supports virtual tunnels), Address Resolution Protocol (ARP) suppression may be employed. An ARP request is sent by a requester to learn the MAC address of an electronic device based on the IP address of the electronic device.

An ARP request is a broadcast packet that is broadcast to multiple destinations. In a VXLAN network, if ARP suppression is not activated, then ARP requests can be propagated through the switches of the VXLAN network, which can result in the VXLAN network being flooded with ARP requests that can overburden resources of the switches. However, if ARP suppression is activated in a given switch, the given switch will not forward ARP requests to other entities. This reduces the amount of ARP requests that are propagated in the VXLAN network.

If a silent host is connected to a switch (e.g., any of silent hosts 111 to 114 connected to the switch 102), then ARP suppression may prevent silent hosts from being detected. ARP suppression may cause the switch 102 to not forward an ARP request to a silent host, which can prevent learning of the MAC address of the silent host. If the MAC address of the silent host is not learned, then the switch 102 would not be able to provide a route advertisement for the silent host. A route advertisement includes MAC addresses of electronic devices so that the electronic devices connected to different VTEPs can communicate with each other. If the MAC address of the silent host is not advertised in a route advertisement, then another device would not be able to communicate with the silent host.

In accordance with some examples of the present disclosure, the switch 102 can selectively disable ARP suppression for a port connected to a silent host. For example, in response to detecting that port P1 is connected to a silent host (e.g., 111 in FIG. 1), the switch 102 disables ARP suppression for port P1. Whether ARP suppression is activated or disabled for port P1 can be indicated in the configuration information C1 for port P1. For example, the configuration information C1 can include an ARP suppression flag (e.g., a single bit, multiple bits, or any other indicator) that when set to a first value specifies that ARP suppression is activated, and when set to a different second value specifies that ARP suppression is disabled.

Although ARP suppression is disabled for port P1, ARP suppression may remain activated for other ports (of the switch 102) not connected to silent hosts. Each other port of the switch is associated with a respective configuration including an ARP suppression flag for specifying whether ARP suppression is activated or disabled. By selectively disabling ARP suppression for selected ports connected to silent hosts, ARP requests are propagated through the selected ports to reach the silent hosts so that requesters can learn MAC addresses of the silent hosts. However, the ARP requests are not propagated through other ports with ARP suppression activated to prevent flooding of ARP requests through the other ports.

In response to an ARP reply sent from a silent host responsive to an ARP request sent to the silent host, the switch 102 can obtain the MAC address of the silent host (where the MAC address is included in the ARP reply) and include the MAC address in an EVPN route advertisement sent to other switches.

### Additional Examples

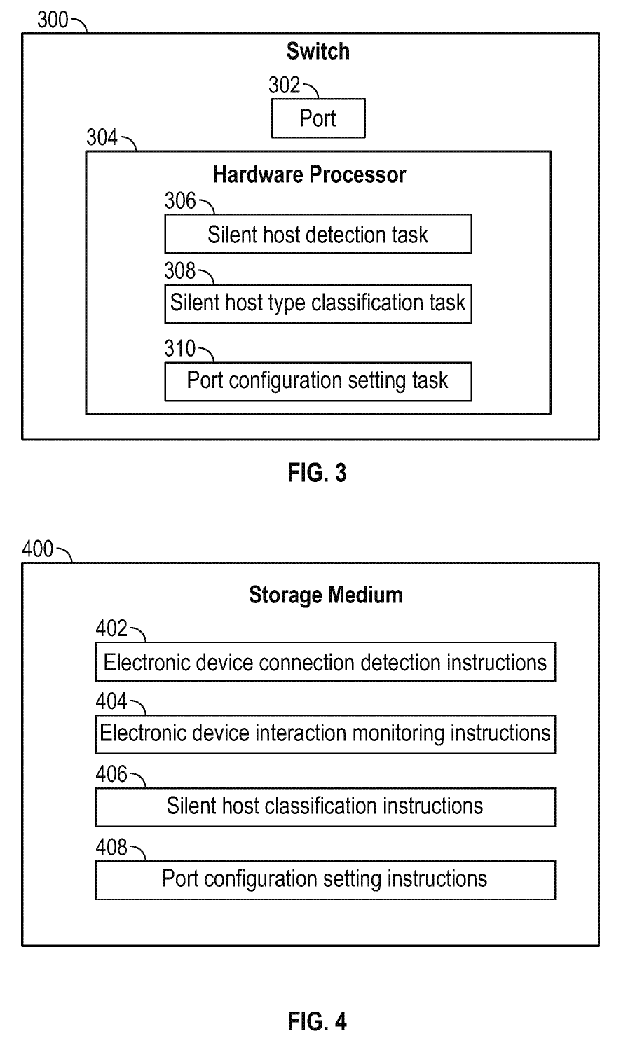

FIG. 3 is a block diagram of a switch 300 according to some examples of the present disclosure. The switch 102 of FIG. 1 is an example of the switch 300 of FIG. 3.

The switch 300 includes a port 302 to connect an electronic device. The switch 300 further includes a hardware processor 304 (or multiple hardware processors). A hardware processor can include a microprocessor, a core of a multi-core microprocessor, a microcontroller, a programmable integrated circuit, a programmable gate array, or another hardware processing circuit.

The hardware processor 304 can perform various tasks. The tasks can be performed under control of machine-readable instructions executed on the hardware processor 304. Alternatively or additionally, the tasks may be performed by hardware processing circuitry of the hardware processor 304. A hardware processor performing a task can refer to a single hardware processor performing the task or multiple hardware processors performing the task.

The tasks of the hardware processor 304 include a silent host detection task 306 to detect that the electronic device is a silent host. The silent host may be one of multiple different silent host types.

The tasks of the hardware processor 304 include a silent host type classification task 308 to classify the electronic device as a selected silent host type from among the different silent host types. The classifying is based on identifying an interaction, from among different types of interactions, between the switch 300 and the electronic device, where the different types of interactions indicate respective silent host types of the different silent host types.

The tasks of the hardware processor 304 include a port configuration setting task 310 to set a configuration associated with the port 302 based on the selected silent host type produced by the classifying. Different port configurations are set for different silent host types.

In some examples, the classifying includes identifying the electronic device as a shy silent host based on detecting that the electronic device goes silent after the electronic device performs authentication with an authentication server through the switch 300. The shy silent host can either be a hibernating shy silent host or a non-hibernating shy silent host.

In some examples, the classifying includes identifying the electronic device as the hibernating shy silent host based on detecting a connection of the port 302 going down due to the electronic device transitioning to a sleep mode.

In some examples, the setting of the configuration associated with the port 302 includes enabling a wake-on-network feature for the port 302 to allow a transmission of a network packet through the port 302 to the electronic device to awaken the electronic device from a sleep mode.

In some examples, the setting of the configuration associated with the port 302 includes caching host information of the electronic device in a memory of the switch 300 based on identifying the electronic device as the hibernating shy silent host. The cached host information can include onboarding information (e.g., 121 in FIG. 1) and forwarding information of the electronic device. The forwarding information may be part of an entry of a forwarding table (e.g., 110 in FIG. 1), for example.

In some examples, the classifying includes identifying the electronic device as a non-hibernating shy silent host based on detecting an inactivity of the electronic device but a connection of the port 302 not going down.

In some examples, the setting of the configuration associated with the port 302 includes disabling an age-out feature for the port 302 to prevent host information of the electronic device from being deleted due to inactivity of the electronic device.

In some examples, the identifying of the electronic device as the shy silent host is further based on detecting that the electronic device announces its presence. The shy silent host may initiate a DHCP procedure, for example.

In some examples, the classifying includes identifying the electronic device as an ultra-silent host that does not announce itself after connecting to the port 302.

In some examples, the identifying of the electronic device as the ultra-silent host is based on detecting a response of the electronic device to a broadcast message sent from the switch 300 through the port 302. The electronic device is identified as a GBR ultra-silent host based on detecting that the electronic device responds to the broadcast message targeted to a broadcast address. The electronic device is identified as a DBR ultra-silent host based on detecting that the electronic device responds to the broadcast message targeted to an IP subnet

In some examples, the setting of the configuration associated with the port 302 includes activating a client probe service on the port 302 to allow sending a broadcast message through the port 302 to the electronic without causing the broadcast message to be sent through another port of the switch 300.

In some examples, based on detecting that the electronic device is the silent host, the switch 300 disables ARP suppression for the port 302 to allow an ARP request to be propagated through the port 302 to the electronic device.

In some examples, the switch 300 receives, from the electronic device, an ARP reply that contains a MAC address of the electronic device. The switch 300 sends, to another network switch, a route advertisement including the MAC address of the electronic device.

FIG. 4 is a block diagram of a non-transitory machine-readable or computer-readable storage medium 400 storing machine-readable instructions that upon execution cause a switch (e.g., 102 in FIG. 1) to perform various tasks. The machine-readable instructions may be part of the port configurator 130 and the silent host classifier 132 of FIG. 1, for example.

The machine-readable instructions include electronic device connection detection instructions 402 to detect a connection of an electronic device to a port of the switch. The connection is detected by detecting that a port link to the port is up.

The machine-readable instructions include electronic device interaction monitoring instructions 404 to monitor an interaction between the electronic device and the switch. Different types of electronic devices will perform different types of interactions with the switch.

The machine-readable instructions include silent host classification instructions 406 to, based on the monitored interaction, classify the electronic device as a selected silent host type from different silent host types. The classifying is based on a type of the interaction from among different types of interactions, where the different types of interactions indicate respective silent host types of the different silent host types.

The machine-readable instructions include port configuration setting instructions 408 to set a configuration associated with the port based on the selected silent host type produced by the classifying. The configuration includes configuration information specifying how host information of the electronic device is to be retained due to inactivity of the electronic device. For example, the configuration information can specify that the host information of the electronic device connected to the port is to be cached. As another example, the configuration information can specify that the age-out feature for the port is to be disabled.

In some examples, the different types of interactions include (1) a first type of interaction in which inactivity of the electronic device causes a connection of the port to go down due to the electronic device transitioning to a sleep mode, (2) a second first type of interaction in which inactivity of the electronic device causes the host information of the electronic device to age out, (3)a third type of interaction in which the electronic device does not announce itself but responds to a broadcast packet targeting a broadcast address, and (4) a fourth type of interaction in which the electronic device does not announce itself but responds to a directed broadcast packet targeting a subnet.

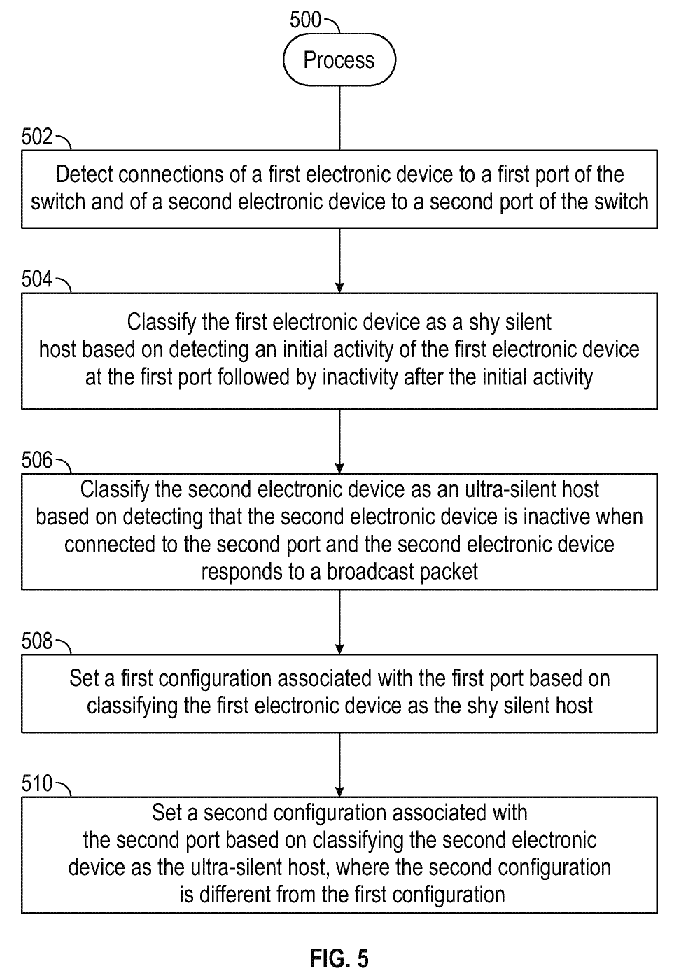

FIG. 5 is a flow diagram of a process 500 according to some examples of the present disclosure. The process 500 may be performed by the switch 102 of FIG. 1, for example.

The process 500 includes detecting (at 502) connections of a first electronic device to a first port of the switch and of a second electronic device to a second port of the switch.

The process 500 includes classifying (at 504) the first electronic device as a shy silent host based on detecting an initial activity of the first electronic device at the port followed by inactivity after the initial activity. The first electronic device may be the hibernating shy silent host 111 or the non-hibernating shy silent host 112 of FIG. 1, for example.

The process 500 includes classifying (at 506) the second electronic device as an ultra-silent host based on detecting that the second electronic device is inactive when connected to the second port and the second electronic device responds to a broadcast packet. The second electronic device can be the GBR ultra-silent host 113 or the DBR ultra-silent host 114 of FIG. 1, for example.

The process 500 includes setting (at 508) a first configuration associated with the first port based on classifying the first electronic device as the shy silent host. The first configuration may be the port configuration C1 or C2 of FIG. 1, for example.

The process 500 includes setting (at 510) a second configuration associated with the second port based on classifying the second electronic device as the ultra-silent host, where the second configuration is different from the first configuration. The second configuration may be the port configuration C3 or C4 of FIG. 1, for example.

As used here, a memory can be implemented with one or more memory devices. A memory device can be any or some combination of the following: a dynamic or static random access memory (a DRAM or SRAM) device, an erasable and programmable read-only memory (EPROM) device, an electrically erasable and programmable read-only memory (EEPROM) device, or a flash memory device.

An electronic device can refer to any or some combination of the following: a desktop computer, a notebook computer, a tablet computer, a smartphone, a game appliance, an Internet-of-Things (IoT) device, a household appliance, a vehicle, or any other type of electronic device.

FIGS. 2 and 5 are flow diagrams of processes including tasks performed in depicted orders. In other examples, the tasks of any of the processes may be performed in a different order, some of the tasks may be omitted, and other tasks may be added.

A storage medium (e.g., 400 in FIG. 4) can include any or some combination of the following: a semiconductor memory device such as a DRAM or SRAM device, an EPROM device, an EEPROM device, or a flash memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term "a," "an," or "the" is intended to include the plural forms as well, unless the context clearly indicates otherwise. Also, the term "includes," "including," "comprises," "comprising," "have," or "having" when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A network switch comprising:
a port to connect an electronic device; and
a hardware processor to:
detect that the electronic device is a silent host;
classify the electronic device as a selected silent host type from different silent host types, the classifying based on identifying an interaction, from among different types of interactions, between the network switch and the electronic device, wherein the different types of interactions indicate respective silent host types of the different silent host types; and
set a configuration associated with the port based on the selected silent host type produced by the classifying.

2. The network switch of claim 1, wherein the classifying comprises:
identifying the electronic device as a shy silent host based on detecting that the electronic device goes silent after the electronic device performs authentication with an authentication server through the network switch.

3. The network switch of claim 2, wherein the classifying comprises:
identifying the electronic device as a hibernating shy silent host based on detecting a connection of the port going down due to the electronic device transitioning to a sleep mode.

4. The network switch of claim 3, wherein the setting of the configuration associated with the port comprises:
enabling a wake-on-network feature for the port to allow a transmission of a network packet through the port to the electronic device to awaken the electronic device from the sleep mode.

5. The network switch of claim 3, wherein the setting of the configuration associated with the port comprises:
caching host information of the electronic device in a memory of the network switch based on identifying the electronic device as the hibernating shy silent host.

6. The network switch of claim 5, wherein the cached host information comprises onboarding information and forwarding information of the electronic device.

7. The network switch of claim 2, wherein the classifying comprises:
identifying the electronic device as a non-hibernating shy silent host based on detecting an inactivity of the electronic device but a connection of the port not going down.

8. The network switch of claim 7, wherein the setting of the configuration associated with the port comprises:
disabling an age-out feature for the port to prevent host information of the electronic device from being deleted due to inactivity of the electronic device.

9. The network switch of claim 2, wherein the identifying of the electronic device as the shy silent host is further based on detecting that the electronic device announces its presence.

10. The network switch of claim 1, wherein the classifying comprises:
identifying the electronic device as an ultra-silent host that does not announce itself after connecting to the port.

11. The network switch of claim 10, wherein the identifying of the electronic device as the ultra-silent host is based on detecting a response of the electronic device to a broadcast message sent from the network switch through the port.

12. The network switch of claim 11, wherein the identifying identifies the electronic device as a general-broadcast-responsive (GBR) ultra-silent host based on detecting that the electronic device responds to the broadcast message targeted to a broadcast address.

13. The network switch of claim 11, wherein the identifying identifies the electronic device as a directed-broadcast-responsive (DBR) ultra-silent host based on detecting that the electronic device responds to the broadcast message targeted to an Internet Protocol (IP) subnet.

14. The network switch of claim 10, wherein the setting of the configuration associated with the port comprises:
activating a client probe service on the port to allow sending a broadcast message through the port to the electronic device without causing the broadcast message to be sent through another port of the network switch.

15. The network switch of claim 1, wherein the hardware processor is to:
based on detecting that the electronic device is the silent host, disable Address Resolution Protocol (ARP) suppression for the port to allow an ARP request to be propagated through the port to the electronic device.

16. The network switch of claim 15, wherein the hardware processor is to:
receive, from the electronic device, an ARP reply that contains a Media Access Control (MAC) address of the electronic device; and
send, from the network switch to another network switch, a route advertisement including the MAC address of the electronic device.

17. A non-transitory machine-readable storage medium comprising instructions that upon execution cause a network switch to:
detect a connection of an electronic device to a port of the network switch;
monitor an interaction between the electronic device and the network switch;
based on the monitored interaction, classify the electronic device as a selected silent host type from different silent host types, the classifying based on a type of the interaction from among different types of interactions, wherein the different types of interactions indicate respective silent host types of the different silent host types; and
set a configuration associated with the port based on the selected silent host type produced by the classifying, the configuration comprising configuration information specifying how host information of the electronic device is to be retained due to inactivity of the electronic device.

18. The non-transitory machine-readable storage medium of claim 17, wherein the different types of interactions comprise:
a first type of interaction in which inactivity of the electronic device causes a connection of the port to go down due to the electronic device transitioning to a sleep mode,
a second first type of interaction in which inactivity of the electronic device causes the host information of the electronic device to age out,
a third type of interaction in which the electronic device does not announce itself but responds to a broadcast packet targeting a broadcast address, and
a fourth type of interaction in which the electronic device does not announce itself but responds to a directed broadcast packet targeting a subnet.

19. A method comprising:
detecting, by a network switch, connections of a first electronic device to a first port of the network switch and of a second electronic device to a second port of the network switch;
classifying, by the network switch, the first electronic device as a shy silent host based on detecting an initial activity of the first electronic device at the first port followed by inactivity after the initial activity;
classifying, by the network switch, the second electronic device as an ultra-silent host based on detecting that the second electronic device is inactive when connected to the second port and the second electronic device responds to a broadcast packet;
setting, by the network switch, a first configuration associated with the first port based on classifying the first electronic device as the shy silent host; and
setting, by the network switch, a second configuration associated with the second port based on classifying the second electronic device as the ultra-silent host, wherein the second configuration is different from the first configuration.

20. The method of claim 19, wherein the initial activity of the first electronic device comprises a Dynamic Host Configuration Protocol (DHCP) message from the first electronic device.
